(19) United States
(12) Patent Application Publication
(10) Pub. No.: US 2007/0017294 A1
(43) Pub. Date: Jan. 25, 2007

(54) Semiconductor pressure sensor

(75) Inventors: Shinsuke Asada, Tokyo (JP); Hiroshi Nakamura, Tokyo (JP); Masaaki Taruya, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 11/287,281

(22) Filed: Nov. 28, 2005

(30) Foreign Application Priority Data
Jul. 22, 2005 (JP) 2005-212438

(51) Int. Cl. G01L 9/00

(52) U.S. Cl. 73/754

(57) ABSTRACT

A semiconductor pressure sensor can simplify conveyance equipment on a production line, improve production operation efficiency to a substantial extent, and reduce the production cost. The semiconductor pressure sensor includes a semiconductor sensor chip for detecting pressure, a processing circuit for correcting and amplifying an electric signal from the semiconductor sensor chip, a sub package having a terminal electrically connected to the semiconductor sensor chip and the processing circuit through bonding wires, and a housing integrally formed with the sub package at an outer side thereof by insert molding. The sub package is formed with a mounting surface on which the semiconductor sensor chip and the processing circuit are mounted.

### BACKGROUND OF THE INVENTION

1. Field of the Invention

The present invention relates to a semiconductor pressure sensor that is used to measure the intake pressure of an automotive engine, for example.

2. Description of the Related Art

As a conventional semiconductor pressure sensor, there has been known a semiconductor sensor which includes a housing made of resin with a conductor being integrated therewith by insert molding, a semiconductor sensor chip mounted on the housing, and a processing circuit IC that is also mounted on the housing for amplifying and adjusting the characteristics of this semiconductor sensor chip. The semiconductor sensor further includes bonding wires that serve to electrically connect the semiconductor sensor chip, the processing circuit IC and conductors such as terminals with one another, and a protective resin layer that serves to cover the semiconductor sensor chip, the processing circuit IC, the conductors and the bonding wires so as to prevent their corrosion due to a medium to be measured as well as to ensure their electrical insulation (see, for instance, a first patent document: Japanese patent application laid-open No. 2000-162075 (FIG. 1)).

In the case of the semiconductor pressure sensor as constructed above, however, a plurality of conductors are formed integral with the housing by insert molding, and hence the existence of the plurality of conductors when the housing is produced by means of insert molding results in an accordingly complicated configuration of a mold, and an increased period of time is also required for molding operation, thus leading to an increase in the production cost.

For these reasons, in actuality, a sub package main body is first formed which is integrated by insert molding with a lead frame with which a plurality of conductors are connected, and then the connecting portions of the lead frame with the sub package main body are cut to produce a sub package with the conductors being made independent from one another, after which a housing is formed outside the sub package by means of insert molding with the sub package being used as an insert part. Thus, the production cost is often intended to be reduced.

In the semiconductor pressure sensor of the above-mentioned construction, however, the sub package is not provided with a mounting surface for the semiconductor sensor chip and the processing circuit IC, and hence it is necessary to mount the semiconductor sensor chip and the processing circuit IC on the mounting surface of the housing after the housing is formed outside of the sub package by means of insert molding.

That is, it is necessary to perform, after the sub package is integrated with the housing, respective steps required for the production process of the semiconductor pressure sensor such as a die bonding step, a wire bonding step, a step of forming the protective resin layer, a sensor characteristic adjustment step, etc.

Therefore, in the production process, the housing is conveyed on a production line while being mounted on a conveyance tray, but in case where a plurality of housings of different shapes are produced with the same production line, there arises a problem that it is necessary to prepare conveyance trays suited to the individual housing shapes, and to make setup changes of conveyance equipment.

In addition, since a housing is a relatively large part, there is also another problem that the number of treatments per heating tank required when a die bonding material and a protective resin material are cured is decreased in a die bonding step and a protective resin layer forming step.

Moreover, large parts have large thermal capacities, so there is a further problem, too, that a long temperature change time is required in a residual heat treatment in the wire bonding process, or in characteristics adjustment steps, particularly, in a temperature characteristic adjustment step.

Consequently, these problems become causes for raising the production cost.

### SUMMARY OF THE INVENTION

Accordingly, the present invention is intended to obviate the above-mentioned problems, and has for its object to obtain a semiconductor pressure sensor which is capable of simplifying conveyance equipment on a production line, improving production operation efficiency to a substantial extent, and reducing the production cost.

A semiconductor pressure sensor according to the present invention includes: a semiconductor sensor for detecting pressure; a processing circuit part for correcting and amplifying an electric signal from the semiconductor sensor; a sub package having a terminal electrically connected to the semiconductor sensor and the processing circuit part through bonding wires; and a housing integrally formed with the sub package at an outer side thereof by insert molding. The sub package is formed with a mounting surface on which the semiconductor sensor and the processing circuit part are mounted.

According to the semiconductor pressure sensor of the present invention, conveyance equipment on a production line can be simplified, and the production operation efficiency can be greatly improved, and the manufacturing cost can be reduced.

The above and other objects, features and advantages of the present invention will become more readily apparent to those skilled in the art from the following detailed description of preferred embodiments of the present invention taken in conjunction with the accompanying drawings.

### BRIEF DESCRIPTION OF THE DRAWINGS

FIG. 1 is a cross sectional view showing a semiconductor pressure sensor according to a first embodiment of the present invention.

FIG. 2 is a plan view showing the interior of a housing of FIG. 1.

FIG. 3 is a plan view showing the appearance of a lead frame and a sub package main body integrally formed with each other in the process of production of the semiconductor pressure sensor of FIG. 1.

FIG. 4 is a cross sectional view showing the essential portions of a semiconductor pressure sensor according to a second embodiment of the present invention.

### DESCRIPTION OF THE PREFERRED EMBODIMENTS

Now, preferred embodiments of the present invention will be described in detail while referring to the accompanying drawings. Throughout the following embodiments and illustrated figures of the present invention, the same or corresponding members or parts are identified by the same symbols.

Embodiment 1.

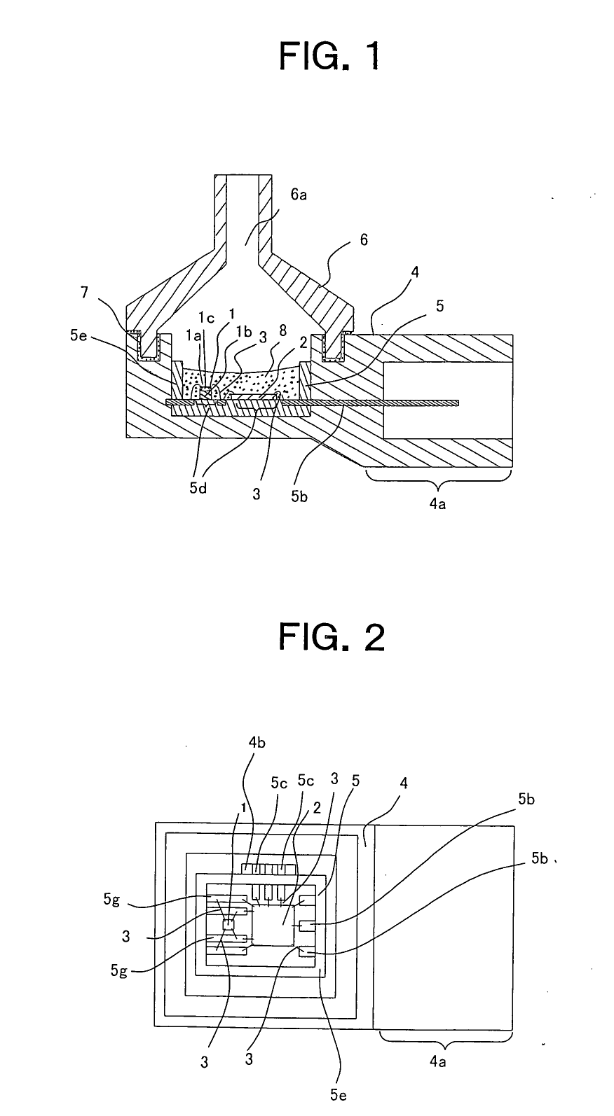

FIG. 1 is a cross sectional view that shows a semiconductor pressure sensor according to a first embodiment of the present invention, and FIG. 2 is a plan view that shows a housing of FIG. 1.

In this semiconductor pressure sensor, a semiconductor sensor in the form of a semiconductor sensor chip 1 and a processing circuit part in the form of a processing circuit IC2 are mounted on a mounting surface 5d of a bottom of a box-shaped sub package 5. The sub package 5 is integrally formed with a housing 4 having a connector 4a by means of insert molding. A port 6 with a pressure introduction hole 6a is connected with the housing 4 by using an adhesive, so that pressure transmits to the semiconductor sensor chip 1 by way of the pressure introduction hole 6a.

The sub package 5 includes a sub package main body 5a of a channel or C shape in cross section having the mounting surface 5d on which the semiconductor sensor chip 1 and the processing circuit IC2 are mounted, a connector terminal 5b, an adjustment terminal 5c, and an interconnection or internal wiring 5g.

The semiconductor sensor chip 1 is a well-known one using a piezoresistive effect, and is comprised of a silicon chip 1a with a diaphragm, and a glass seat 1b that is anodically bonded to the silicon chip 1a. A vacuum chamber 1c is formed in a lower portion of the diaphragm by the connection of the silicon chip 1a and the glass seat 1b. The pressure in the port 6 is output as an electric signal by detecting the strain or distortion of the diaphragm, which is generated by a pressure difference on the opposite sides thereof, i.e., between the pressure in the vacuum chamber 1c and the pressure at a side opposite the vacuum chamber 1c, from a change in the resistance value of a gauge resistance formed on the diaphragm.

The processing circuit IC2, which constitutes the processing circuit part, includes an amplifier circuit that amplifies an electric signal, an adjustment circuit that performs a desired characteristics adjustment, and a ROM that stores adjustment data. The characteristics adjustment is performed by inputting the electric signal from the semiconductor sensor chip 1 to the adjustment circuit through the adjustment terminal 5c.

The semiconductor sensor chip 1 and the processing circuit IC2 are attached to the mounting surface 5d through a die bonding material such as, for example, fluoroelastomer, etc. The processing circuit IC2 is electrically connected to the connector terminal 5b, the adjustment terminal 5c and the internal wiring 5g through bonding wires 3 such as gold wires, respectively. Also, the semiconductor sensor chip 1 is electrically connected to the internal wiring 5g through a bonding wire 3 such as a gold wire.

The semiconductor sensor chip 1, the processing circuit IC2, the connector terminal 5b, the adjustment terminal 5c, the internal wiring 5g and the bonding wires 3 are covered with a protective resin layer 8 such as, for example, a fluorine gel, etc., so that the corrosion of these component parts due to a medium to be measured can be prevented, and at the same time the electric insulation thereof can be ensured.

The housing 4 is formed of a thermoplastic resin such as, for example, PBT (polybutylene terephthalate) resin by means of insert molding with the sub package 5 used as an insert part according to an injection molding process. At this time, an inner side area of the sub package 5 is exposed from the molding resin, and at a side of the housing 4 near the adjustment terminal 5c, too, a hole 4b is formed in an intermediate portion of the adjustment terminal 5c. With the formation of this hole 4b, information on the ROM written in the processing circuit IC2 can be read out after the sub package 5 is molded to the housing 4.

Here, note that this hole 4b is not indispensable but may be omitted.

Next, reference will be made to the procedure of producing the semiconductor pressure sensor as constructed above.

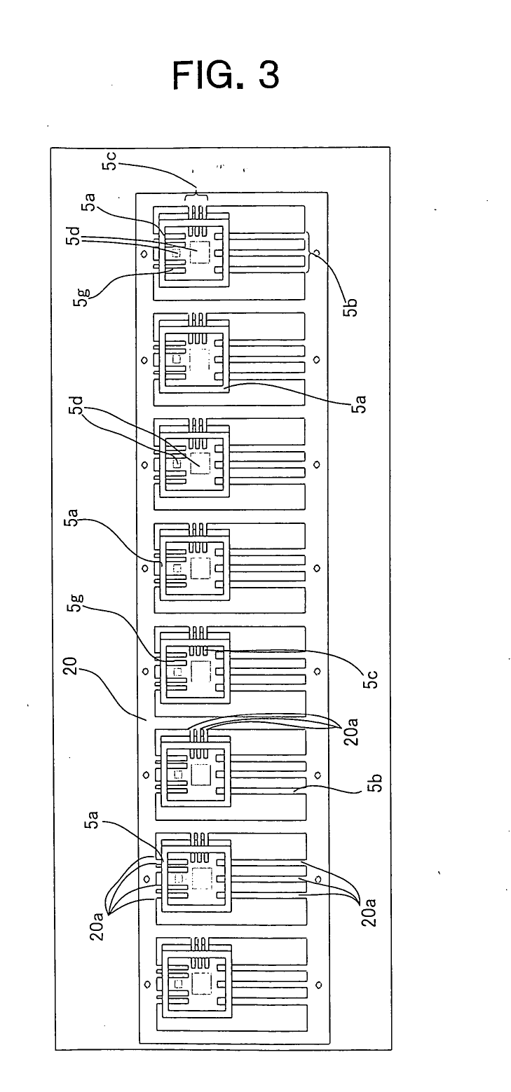

First of all, as shown in FIG. 3, a plurality of sub package main bodies 5a made of epoxy resin are formed on a lead frame 20 by insert molding according to a transfer molding method.

Then, a semiconductor sensor chip 1 and a processing circuit IC2 are die bonded to the mounting surface 5d of each sub package main body 5a through a die bonding material such as, for example, fluoroelastomer, etc.

Subsequently, each processing circuit IC2 is electrically connected to an associated connector terminal 5b, an associated adjustment terminal 5c and an associated internal wiring 5g through bonding wires 3, respectively, and each semiconductor sensor chip 1 is electrically connected to an associated internal wiring 5g through a bonding wire 3.

Thereafter, a protective resin material such as a fluorine gel or the like is filled into each sub package 5 to form a protective resin layer 8 that covers the semiconductor sensor chip 1, the processing circuit IC2, the connector terminal 5b, the adjustment terminal 5c, the internal wiring 5g and the bonding wires 3.

Thereafter, parts of connecting portions 20a of the lead frame 20 are cut away, so that the sensor characteristics of each sensor unit, being thus made electrically independent from one another, are adjusted by inputting an electric signal through the adjustment terminal 5c of the sensor unit.

Next, the remainder of the connecting portions 20a are cut away to form sub packages 5 which are individually separated from one another.

Thereafter, housings 4 are formed of a thermoplastic resin such as PBT resin with the sub packages 5 used as insert parts by means of insert molding according to an injection molding process.

Finally, each port 6 is connected with a corresponding housing 4 through an adhesive.

As described in the foregoing, according to the semiconductor pressure of this first embodiment, the sub package 5 is formed with the mounting surface 5d on which the semiconductor sensor chip 1 and the processing circuit IC2 are mounted, so it is possible to perform die bonding, wire bonding, formation of the protective resin layer 8, and adjustment of the sensor characteristics in a state of the lead frame 20 before formation of the housing 4.

Accordingly, the use of a conveyance tray becomes unnecessary, and even for sub packages 5 of different configurations, the setup change of conveyance equipment is not needed if the outer configurations of lead frames 20 are made uniform.

In addition, since the sub package 5 is small in size in comparison with the housing 4, the number of treatments per heating tank when the die bonding material and the protection resin are heat hardened can be increased, and the time for residual heat treatment in the wire bonding process and the temperature change time in the adjustment step for the sensor characteristics can be shortened.

Accordingly, the operational performance of the respective steps can be improved to a substantial extent, as a result of which the production cost can be reduced.

Moreover, since the sub package main body 5a of each sub package 5 is of channel shape in cross section so as form the wall portion 5e that encloses the semiconductor sensor chip 1, the processing circuit IC2, and the bonding wires 3, the semiconductor sensor chip 1, the processing circuit IC2 and the bonding wires 3 are less prone to be subject to an external force particularly along the direction of conveyance in the production process of the semiconductor pressure sensor, and hence are accordingly more resistant to damage.

Further, by filling the protective resin material into the wall portion 5e, the protective resin layer 8, which covers the semiconductor sensor chip 1, the processing circuit IC2, the connector terminal 5b, the adjustment terminal 5c, the internal wiring 5g and the bonding wires 3, is formed in a reliable manner.

Embodiment 2.

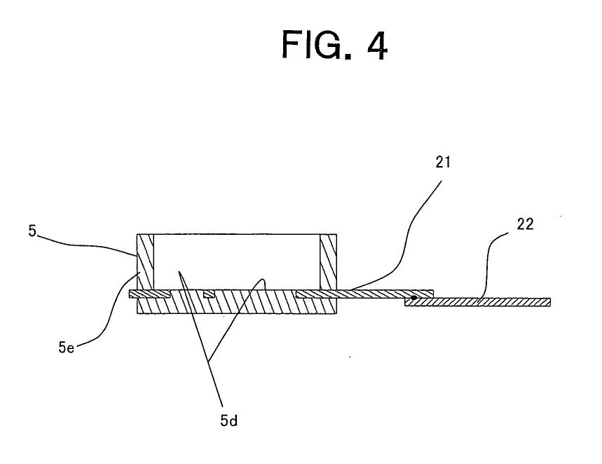

FIG. 4 is a cross sectional view that shows the essential portions of a semiconductor pressure sensor according to a second embodiment of the present invention.

This second embodiment is different from the above-mentioned first embodiment in that a connector terminal 22 is connected by resistance welding to a conductor 21 which is a component element of a lead frame.

The construction of this second embodiment other than the above is the same as that of the semiconductor pressure sensor according to the first embodiment, and can provide the same advantageous effects as those obtained by the first embodiment.

Although in the first and second embodiments, the sub package main body 5a is formed by using epoxy resin that is a thermosetting resin, it may be formed by using a thermoplastic resin such as PBT (polybutylene terephthalate) resin, for example.

In addition, the semiconductor sensor chip 1 is not limited to a pressure detection type using a piezoresistive effect. For example, a semiconductor pressure sensor chip of a capacitance type can be used.

Moreover, although in the first and second embodiments, the semiconductor sensor chip 1 and the processing circuit IC2 are formed separately from each other, they can be composed of an IC having, on the one and same chip, a semiconductor sensor that serves to detect pressure and a processing circuit part that serves to correct and amplify an electric signal from the semiconductor sensor. In this case, the semiconductor pressure sensor can be reduced in size.

Further, the semiconductor sensor chip 1 and the processing circuit IC2 are die bonded to the mounting surface 5d of the sub package main body 5a through the die bonding material such as, for example, fluoroelastomer, etc, but the semiconductor sensor chip 1 and the processing circuit IC2 may be mounted on the internal wiring 5g of the sub package 5.

While the invention has been described in terms of preferred embodiments, those skilled in the art will recognize that the invention can be practiced with modifications within the spirit and scope of the appended claims.

What is claimed is:

1. A semiconductor pressure sensor comprising:
a semiconductor sensor for detecting pressure;
a processing circuit part for correcting and amplifying an electric signal from said semiconductor sensor;
a sub package having a terminal electrically connected to said semiconductor sensor and said processing circuit part through bonding wires; and
a housing integrally formed with said sub package at an outer side thereof by insert molding;
wherein said sub package is formed with a mounting surface on which said semiconductor sensor and said processing circuit part are mounted.

2. The semiconductor pressure sensor as set forth in claim 1, wherein said sub package is provided with a sub package main body made of a resin and taking the form of a channel shape in cross section, and said terminal built into said sub package main body.

3. The semiconductor pressure sensor as set forth in claim 1, wherein said semiconductor sensor and said processing circuit section are composed of an IC formed on the one and same chip.
